(19) United States
(12) Patent Application Publication
(10) Pub. No.: US 2025/0020795 A1
(43) Pub. Date: Jan. 16, 2025

(54) SYSTEMS AND TECHNIQUES FOR IMPLEMENTING RADIO DETECTION AND RANGING (RADAR) USING EXTERNAL SENSOR FEEDBACK

(71) Applicant: GM Cruise Holdings LLC, San Francisco, CA (US)

(72) Inventor: Burkay Donderici, Burlingame, CA (US)

(21) Appl. No.: 18/352,564

(22) Filed: Jul. 14, 2023

(51) Int. Cl. G01S 13/86; G01S 13/931; G06T 7/70; G06V 10/25; G06V 10/26; G06V 10/82; G06V 20/56

(52) U.S. Cl. CPC G01S 13/867; G01S 13/931; G06T 7/70; G06V 10/25; G06V 10/26; G06V 10/82; G06V 20/56; G01S 7/417; G06T 2207/20081; G06T 2207/20084; G06T 2207/30252

(57) ABSTRACT

Systems and techniques are provided for performing RADAR sensing based on external sensor feedback. An example method includes receiving position data associated with at least one object, wherein the position data is based on sensor data obtained by at least one sensor; identifying, based on the position data, at least one subspace from a field of view of a radar sensor, and collecting radar sensing data from the at least one subspace, wherein the radar sensing data corresponds to the at least one object.

### BACKGROUND

### 1. Technical Field

The present disclosure generally relates to autonomous vehicles and, more specifically, to systems and techniques for implementing Radio Detection and Ranging (RADAR) using feedback from external sensors.

### 2. Introduction

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, an image sensor can be used to capture frames (e.g., video frames and/or still pictures/images) depicting a target(s) from any electronic device equipped with an image sensor. As another example, a light detection and ranging (LiDAR) sensor can be used to determine ranges (variable distance) of one or more targets by directing a laser to a surface of an entity (e.g., a person, an object, a structure, an animal, etc.) and measuring the time for light reflected from the surface to return to the LiDAR.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, according to some examples of the present disclosure;

FIG. 2 is a diagram illustrating an example RADAR sensor, according to some examples of the present disclosure;

FIG. 3 is a diagram illustrating an example system for implementing RADAR sensing using data from an external sensor, according to some examples of the present disclosure;

FIG. 4A and FIG. 4B illustrate examples of three-dimensional grids for processing RADAR data, according to some examples of the present disclosure;

FIG. 5 illustrates an example of a deep learning neural network that can be used to implement aspects of object detection for use by a RADAR sensor, according to some aspects of the present disclosure;

FIG. 6 is a flowchart illustrating an example process for implementing RADAR sensing using prior data from an external sensor, according to some aspects of the present disclosure;

FIG. 7 is a flowchart illustrating another example process for implementing RADAR sensing using prior data from an external sensor, according to some aspects of the present disclosure; and

FIG. 8 is a diagram illustrating an example system architecture for implementing certain aspects described herein, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Generally, sensors are integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, an image sensor can be used to capture frames (e.g., video frames and/or still pictures/images) depicting a target(s) from any electronic device equipped with an image sensor. As another example, a light detection and ranging (LiDAR) sensor can be used to determine ranges (variable distance) of one or more targets by directing a laser to a surface of an entity (e.g., a person, an object, a structure, an animal, etc.) and measuring the time of flight (e.g., time to receive reflection corresponding to LiDAR transmission). As another example, a RADAR sensor can be used to identify objects and measure range (e.g., distance) to an object as well as to determine movement of an object.

In a RADAR system, a transmitter is used to transmit electromagnetic waves and a receiver is used to receive reflections (e.g., echoed electromagnetic waves) corresponding to the transmitted waves. In some cases, the reflected waves can be received from many different directions due to backscattering. In addition, multipath and/or multibounce of reflected waves can cause spurious echoes that can result in false detections which must be processed and/or filtered by the RADAR sensor. Consequently, processing RADAR data can be time-consuming such that RADAR detections may become stale for time-sensitive applications such as perception tasks performed by an autonomous vehicle.

Systems, apparatuses, processes (also referred to as methods), and computer-readable media (collectively referred to as “systems and techniques”) are described herein for implementing RADAR sensing using data from an external sensor. In some aspects, data from an external sensor such as an imaging sensor, LIDAR sensor, ultrasonic sensor, etc. can be used to identify one or more objects in a scene. In some cases, the data from the external sensor can be used to predict a future position of said object. In some instances, the predicted future position of the object can be provided to a RADAR sensor so that the RADAR sensor can collect RADAR data corresponding to the object when it is located at the predicted future position. In some aspects, the RADAR sensor may operate more efficiently (e.g., faster processing of RADAR detections) by prioritizing RADAR data corresponding to a location within a scene where an object is located (e.g., based on prior datA from an external sensor).

In some configurations, the external sensor data can be processed by a machine learning model. That is, a machine learning model can use data from imaging sensors, ultrasonic sensors, etc. to identify the current location of an object and predict the future location of the object such that the future location coincides with a future reading conducted by the RADAR sensor. In some aspects, the machine learning model may be implemented within the RADAR sensor such that the external sensor data is provided directly to the RADAR sensor.

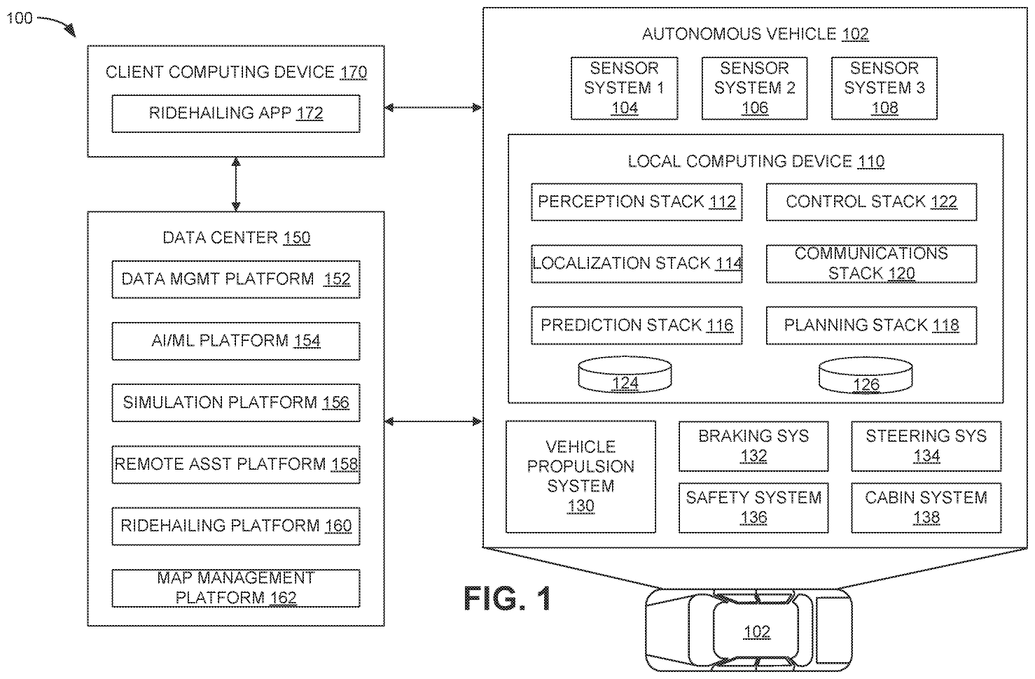

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls layer can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 to enable passengers to view the AV 102 in transit en route to a pick-up or drop-off location, and so on.

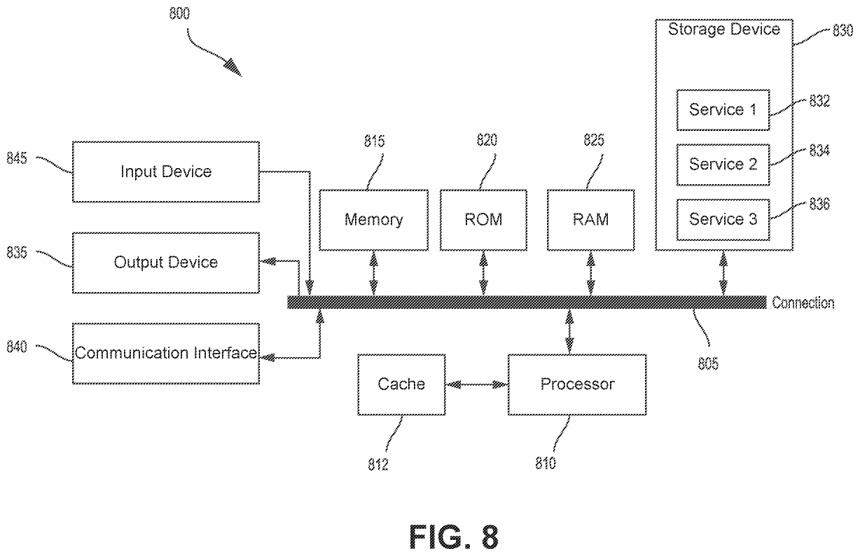

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 8.

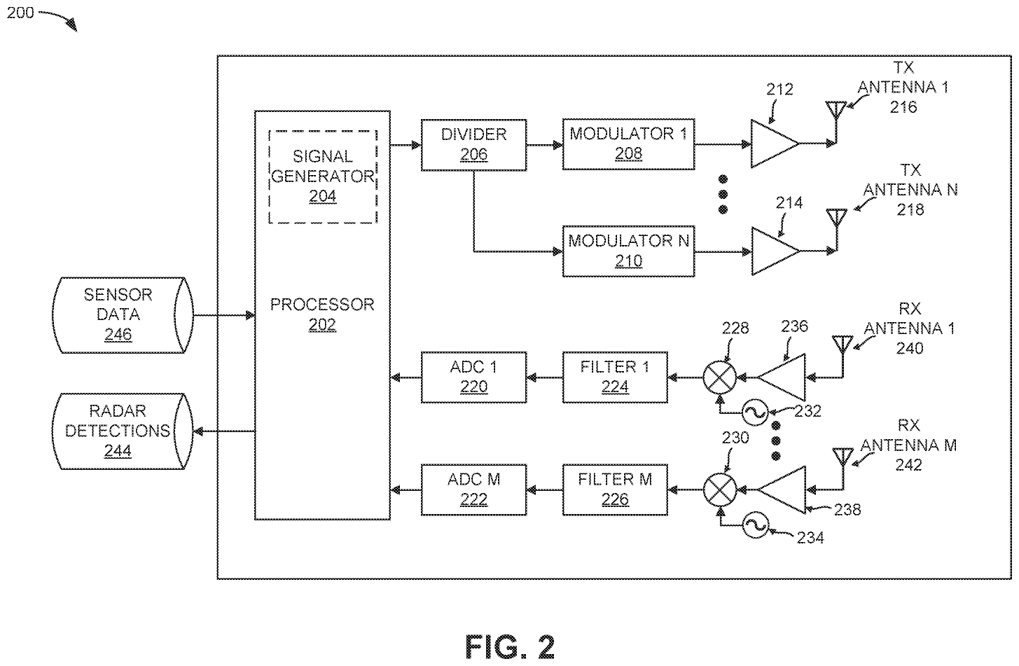

FIG. 2 is a diagram illustrating an example of a RADAR sensor 200. In some aspects, RADAR 200 can include a processor 202. In some cases, processor 202 can be configured to execute firmware and/or control/configure one or more elements, modules, circuits, etc. of RADAR 200. For example, processor 202 may include a digital signal processor (DSP) that may be configured to process RADAR signals. In some cases, the RADAR signals may include a pulsed signal (e.g., intrapulse modulated signal, keyed pulse signal, etc.), a continuous wave (CW) signal (e.g., a frequency modulated continuous wave (FMCW) signal, an unmodulated CW signal, etc.), and/or any other type of RADAR signal.

In some examples, processor 202 may include a signal generator 204 and/or processor 202 may interface with an external signal generator 204. In some aspects, signal generator 204 may include firmware and/or circuitry (e.g., amplifiers, filters, etc.) for generating a RADAR signal (e.g., FMCW signal).

In some aspects, the electronics within RADAR 200 may include one or more components that are configured to transmit a RADAR signal. For example, RADAR 200 may include a power divider 206 that can receive the RADAR signal (e.g., output from signal generator 204) and can generate ‘N’ copies of the RADAR signal for transmission. In some cases, a portion of the signal can be transmitted, and another portion may be used as a local oscillator frequency (e.g., local oscillator 232 and/or local oscillator 234). In some examples, the electronics can include ‘N’ modulators such as modulator 208 and modulator 210. In some aspects, modulator 208 and/or modulator 210 can be configured to perform phase modulation on the RADAR signal received from the power divider 206. In some configurations, the modulators can be coupled to one or more power amplifiers (PAS) such as PA 212 and/or PA 214. In some instances, the PAs can be coupled to ‘N’ transmitting antennas such as TX antenna 216 and/or TX antenna 218. In some examples, the transmitting antennas may be part of an antenna array (e.g., a two-dimensional antenna array, a linear antenna array, or any other suitable antenna configuration).

In some cases, the electronics within RADAR 200 can include one or more elements for receiving echo signals (e.g., reflections of the signals emitted by the transmitting antennas off of objects in a scene). For example, RADAR 200 can include M receiving antennas such as RX antenna 240 and RX antenna 242. In some cases, the RX antennas may be coupled to ‘M’ low-noise amplifiers (LNAs) such as LNA 236 and/or LNA 238 that can be configured to amplify signals received by RX antenna 240 and/or RX antenna 242.

In some instances, RADAR 200 can include ‘M’ mixers such as mixer 228 and/or mixer 230. In some aspects, mixer 228 and/or mixer 230 can be configured to downmix the amplified electrical signals output by LNA 236 and/or LNA 238 with a local oscillator (LO) such as LO 232 and/or LO 234. As noted above, in some cases, the power divider 206 may direct copies of the RADAR signal (e.g., FMCW signal) to the mixers such that the RADAR signal is used as the LO (e.g., LO 232 and/or LO 234).

In some aspects, the receiver electronics in RADAR 200 can also include ‘M’ low pass filters such as filter 224 and/or filter 226. In some cases, the filters (e.g., filter 224 and/or filter 226) can be coupled to the mixers (e.g., mixer 228 and/or mixer 230) and can be configured to filter higher frequencies from the downmixed signals. In some configurations, RADAR 200 can include ‘M’ analog-to-digital converters (ADCs) such as ADC 220 and/or ADC 222. In some instances, ADC 220 and/or ADC 222 can be configured to convert the filtered signals from analog signals to digital signals that can be processed by processor 202. That is, the ADCs can digitally sample the filtered signals to generate digital radar data that is indicative of radar returns received by the RX antennas. In some aspects, processor 202 can process the radar data to output one or more radar detections 244 that are indicative of a position of a point or points on a surface of an object in the field of view of RADAR 200. In some cases, the radar detections 244 can further indicate a velocity of the point.

In some examples, RADAR 200 can receive sensor data 246 from an external processor and/or from an external sensor. In some cases, the sensor data 246 can correspond to data obtained by a sensor from sensor systems 104-108 such as an imaging sensor (e.g., camera), a LIDAR sensor, an ultrasonic sensor, another RADAR sensor, and/or any other sensor that may be used to detect objects. In some cases, RADAR 200 can use the sensor data 246 to identify zones or areas within the field of view of RADAR 200 that may contain objects. For example, sensor data 246 may include two-dimensional data (e.g., x, y coordinates; azimuth and elevation angles, etc.) that identifies the position of an object within the field of view of RADAR 200. In another example, sensor data 246 may include three-dimensional data (e.g., x, y, z coordinates; azimuth, elevation, and range; etc.) that identifies the position of an object within the field of view of RADAR 200.

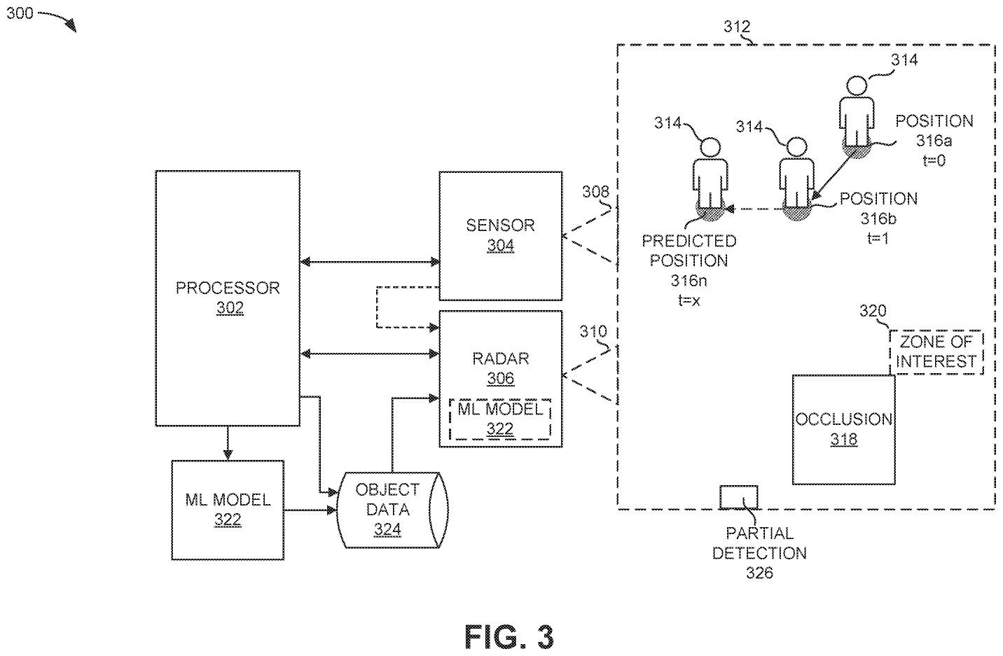

In some cases, sensor data 246 may identify the position of an object within the field of view of RADAR 200 at an earlier or prior time (e.g., sensor data 246 was captured by a sensor at a time (t−x)). In some examples, processor 202 may use the prior information from sensor data 246 to predict a current position of an object. For example, as discussed in further detail below with respect to FIG. 3, RADAR 200 may include a machine learning model that can use sensor data 246 to predict a future position of an object within the field of view of RADAR 200. In some cases, sensor data 246 may identify the position of an object at future times. That is, the machine learning model may be implemented externally to predict future positions of objects and the predicted future positions can be provided as part of sensor data 246.

In some examples, RADAR 200 can use sensor data 246 to identify areas to perform RADAR detections. For example, RADAR 200 can perform beamforming to direct one or more transmission beams and/or one or more reception beams to a location corresponding to the predicted location of an object within the field of view of RADAR 200. In another example, RADAR 200 may use sensor data 246 to process the search grid that includes RADAR data corresponding to the entire field of view of the RADAR. For instance, RADAR 200 may filter points within the search grid to focus on the two-dimensional space that is expected to include an object (e.g., based on sensor data 246). In another example, RADAR 200 may filter points within the search grid to focus on the three-dimensional space that is expected to include an object (e.g., based on sensor data 246).

FIG. 3 is a diagram illustrating an example of a system 300 that illustrates RADAR sensing using feedback from an external sensor. In some aspects, system 300 can include a processor 302 that is coupled to sensor 304 and RADAR 306. In some examples, processor 302 may correspond to local computing device 110 or computing system 800. In some cases, sensor 304 may correspond to a sensor from sensor systems 104-108 such as an imaging sensor, LIDAR sensor, an ultrasonic sensor, etc. In some aspects, RADAR 306 may correspond to RADAR 200.

In some instances, sensor 304 may have a field of view 308 corresponding to scene 312. For instance, sensor 304 may be an imaging sensor (e.g., camera) having a field of view 308 that may capture objects in scene 312. In some configurations, RADAR 306 may have a field of view 310 corresponding to scene 312. It is noted that although the field of view 308 corresponding to sensor 304 and the field of view 310 corresponding to RADAR 306 overlap (e.g., both capture scene 312), such a configuration is not required by the present technology. For example, alternative configurations may include a field of view 308 of sensor 304 that partially overlaps with field of view 310 of RADAR 306. In addition, some aspects of the present technology contemplate that sensor 304 may include multiple sensors and/or different sensor modalities (e.g., sensor 304 may include an imaging sensor and an ultrasonic sensor).

As illustrated, scene 312 includes person 314. In some aspects, sensor 304 may capture sensor data that includes person 314. For example, in the case where sensor 304 corresponds to an image sensor, sensor 304 may capture a first image frame in which person 314 is located at position 316a at a first time (t) (e.g., t=0) and a second image frame in which person 314 is located at position 316b at a second time (e.g., t=1). In some aspects, the sensor data (e.g., image frames) from sensor 304 can be provided to processor 302. In addition, or alternatively, the sensor data from sensor 304 can be provided to RADAR 306.

In some examples, processor 302 may use the sensor data from sensor 304 to determine object data 324. In some cases, all or a portion of object data 324 may be determined by a machine learning (ML) model such as ML model 322. That is, processor 302 may include and/or interface with ML model 322. In some cases, all or a portion of object data 324 may be determined by a processor (e.g., processor 202) and/or an ML model within RADAR 306 (e.g., ML model 322 may be integrated as part of RADAR 306). In some aspects, ML model 322 may include multiple ML models.

In some examples, object data 324 can include object detection(s), object classification(s), object location(s), object speed(s), object direction(s), object tracks(s), object orientation(s), predicted location(s), predicted path(s), occlusion(s), zone(s) of interest, etc. In one illustrative example, ML model 322 may correspond to perception stack 112 that can be configured to use data from sensor 304 to detect and classify objects and determine their current locations, speeds, directions, and the like. For instance, ML model 322 can detect and classify person 314 and determine the location, speed, and direction of person 314 (e.g., person 314 is at position 316a at time t=0).

In some configurations, processor 302 and/or ML model 322 can use the sensor data from sensor 304 to determine a predicted future position of an object within scene 312. For example, processor 302 may use image data provided by sensor 304 to implement a shadow tracking algorithm that can be used to track person 314. In some aspects, the shadow track can be provided to RADAR 306 as part of object data 324. In another example, ML model 322 may correspond to a prediction stack 116 that may be configured to predict one or more future paths for person 314. In one example, ML model 322 may output object data 324 that indicates one or more future positions and/or paths for person 314. In some cases, the predicted paths and/or positions may be associated with a confidence score. For instance, ML model 322 may predict the future position of person 314 at predicted position 316n at a future time (e.g., time t=x) with a confidence of 80%.

In some cases, the future position (e.g., predicted position 316n) may be included as part of object data 324 in the form of a two-dimensional location that is designated by x, y coordinates or by an azimuth angle and an elevation angle. In some instances, the future position (e.g., predicted position 316n) may be included as part of object data 324 in the form of a three-dimensional location that is designated by x, y, and z coordinates or by an azimuth angle, an elevation angle, and a range (e.g., distance) parameter.

In some aspects, processor 302 and/or ML model 322 may use the data from sensor 304 to identify one or more occlusions within scene 312. For example, ML model 322 may use data from sensor 304 to classify occlusion 318. In some cases, ML model 322 may identify a zone of interest 320 that is associated with occlusion 318. In some configurations, zone of interest 320 may correspond to an area from which an object may appear. For example, a pedestrian that is located behind occlusion 318 may become visible upon entering zone of interest 320.

In some examples, ML model 322 can be configured to have a relatively high recall and/or a relatively low precision. That is, ML model 322 can be configured to report object data 324 corresponding to objects that are not classified such as partial detection 326. For example, the data captured by sensor 304 may not be sufficient to detect and/or classify partial detection 326. In some cases, object data 324 may include the location/position and/or predicted location/position/track of partial detection 326 although ML model 322 is unable to detect or classify it or when the confidence score associated with the detection is relatively low.

In some aspects, RADAR 306 can use object data 324 to perform RADAR sensing of scene 312. For example, RADAR 306 can be configured to direct and/or prioritize RADAR sensing at certain locations within scene 312 based on object data 324. In some cases, RADAR 306 may prioritize RADAR sensing by configuring a mode of operation that is based on a range parameter or a transmission parameter. In some cases, RADAR 306 may implement beamforming such that transmission beams and/or reception beams are directed to locations within scene 312. For example, RADAR 306 may use a beamforming algorithm to direct or prioritize a detection in the vicinity of predicted position 316n of person 314 at time t=x. In another example, RADAR 306 may direct or prioritize a detection in the vicinity of zone of interest 320. In another example, RADAR 306 may direct or prioritize a detection in the vicinity of partial detection 326.

In some examples, RADAR 306 may collect RADAR data that is associated with its entire field of view 310. That is, RADAR 306 may collect RADAR data corresponding to the entirety of scene 312. In some aspects, the RADAR data corresponding to scene 312 can correspond to a three-dimensional array (e.g., a three-dimensional grid). In some examples, RADAR 306 may prioritize processing of one or more elements in the three-dimensional array based on object data 324.

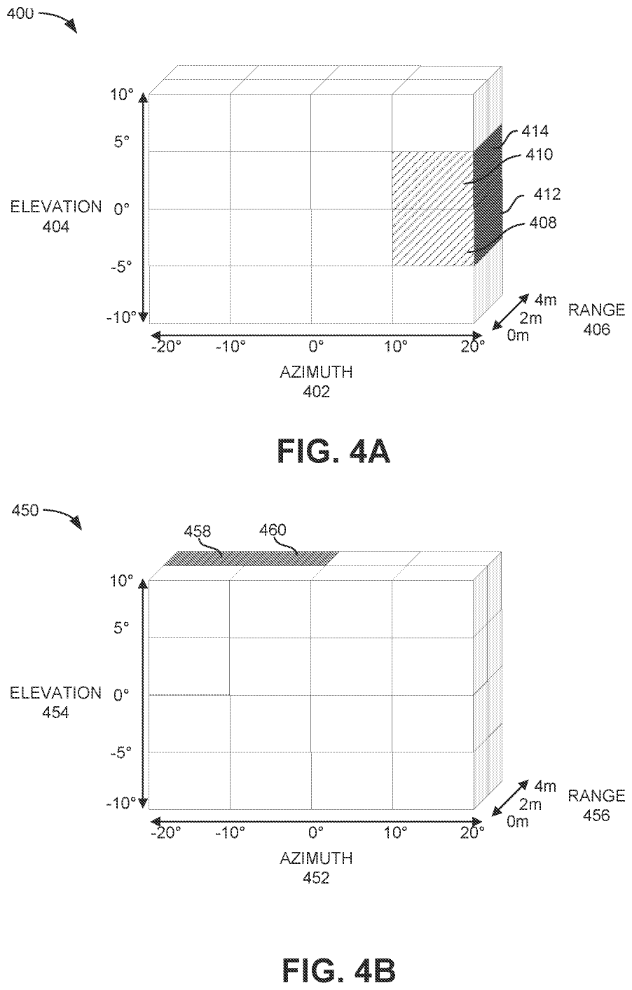

FIG. 4A illustrates an example of a three-dimensional grid 400 that may correspond to RADAR data. In some aspects, the grid 400 may include multiple elements that include RADAR data corresponding to different spaces within a scene. In some instances, the elements within grid 400 can have a corresponding azimuth 402, elevation 404, and range 406.

In some examples, RADAR 306 may receive object data 324 that defines a two-dimensional space. In some aspects, RADAR 306 may process the elements within grid 400 that correspond to the two-dimensional space. In one illustrative example, the two-dimensional space can correspond to an azimuth angle that is between 10 degrees and 20 degrees and an elevation angle that is between −5 degrees and 5 degrees. As illustrated, this two-dimensional space can include element 408 and element 410 having a range value that is between 0 meters and 2 meters as well as element 412 and element 414 having a range value that is between 2 meters and 4 meters. That is, in some cases in which the object data 324 does not include a range parameter, RADAR 306 may process elements associated with different range values that correspond to the two-dimensional space. In some aspects, RADAR 306 may restrict processing and/or search to elements in the search grid (e.g., grid 400) that are consistent with object data 324 (e.g., based on data from sensor 304).

FIG. 4B illustrates another example of a three-dimensional grid 450 that may correspond to RADAR data. As noted with respect to grid 400, grid 450 may include multiple elements that include RADAR data corresponding to different spaces within a scene (e.g., scene 312). In some instances, the elements within grid 450 can have a corresponding azimuth 452, elevation 454, and range 456.

In some examples, RADAR 306 may receive object data 324 that defines a three-dimensional space. In one illustrative example, the three-dimensional space can correspond to an azimuth angle that is between −15 degrees and −5 degrees; an elevation angle that is between 5 degrees and 10 degrees; and a range parameter that is between 3 meters and 4 meters. As illustrated, this three-dimensional space can include portions of two elements, namely, element 458 and element 460. In some cases, RADAR 306 may prioritize processing of the three-dimensional space (e.g., element 458 and element 460). For instance, RADAR detections corresponding to element 458 and/or element 460 may be reported to processor 302 prior to detections corresponding to other elements within grid 450.

Returning to FIG. 3, in some aspects, processor 302 may configure RADAR 306 to collect RADAR data based on one or more heuristics. For instance, processor 302 may configure RADAR 306 to collect RADAR data corresponding to long range detections (e.g., greater than 50 meters). In another example, processor 302 may configure RADAR 306 to collect RADAR data corresponding to short-range detections (e.g., less than 25 meters).

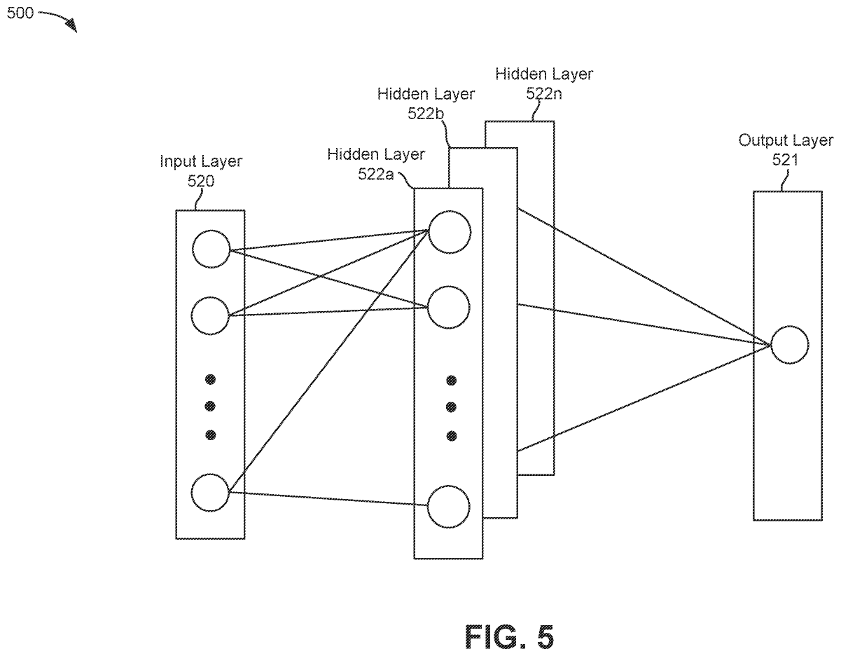

In FIG. 5, the disclosure now turns to a further discussion of models that can be used through the environments and techniques described herein. FIG. 5 is an example of a deep learning neural network 500 that can be used to implement all, or a portion of the systems and techniques described herein as discussed above (e.g., neural network 500 can be used to implement ML model 322). For example, an input layer 520 can be configured to receive sensor data (e.g., data from sensor 304) from an imaging sensor, a LIDAR sensor, an ultrasonic sensor, and/or any other type of sensor. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n. For instance, the output may include object identification, object classification, object position, object trajectory, bounding box, predicted position at future time(s), predicted trajectory, occlusion identification, zone of interest, etc. The output can be provided to a RADAR sensor for prioritizing and/or targeting an area when performing RADAR sensing.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

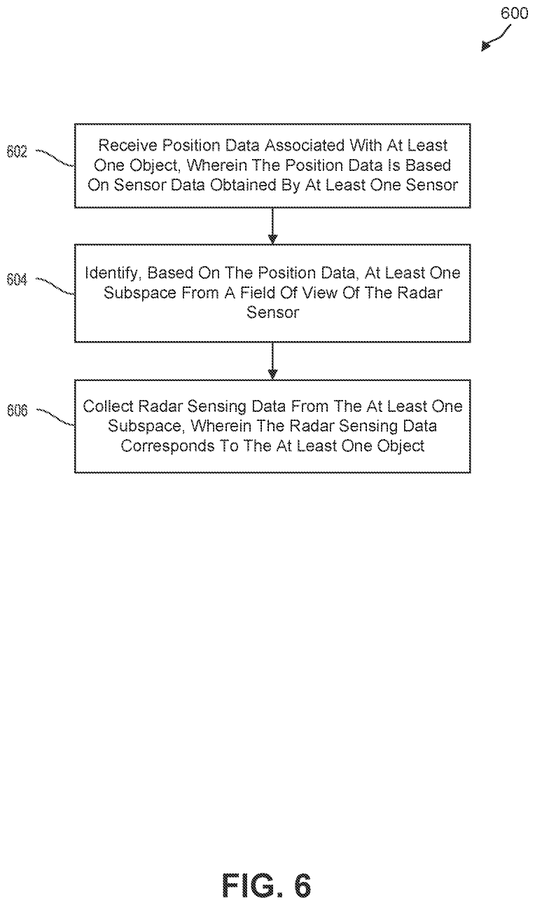

FIG. 6 illustrates a flowchart of an example process 600 for implementing RADAR sensing using prior data from an external sensor. Although the process 600 depicts a particular sequence of operations, the sequence may be altered without departing from the scope of the present disclosure. For example, some of the operations depicted may be performed in parallel or in a different sequence that does not materially affect the function of process 600. In other examples, different components of an example device or system that implements process 600 may perform functions at substantially the same time or in a specific sequence.

At step 602, the process 600 includes receiving position data associated with at least one object, wherein the position data is based on sensor data obtained by at least one sensor. For example, RADAR 306 can receive position data (e.g., object data 324 that includes position 316a and/or position 316b) associated with person 314, wherein the position data is based on sensor data obtained by sensor 304. In some cases, the at least one sensor can include at least one of an image sensor, a LIDAR sensor, and an ultrasonic sensor.

At step 604, the process 600 includes identifying, based on the position data, at least one subspace from a field of view of the radar sensor. For instance, RADAR 306 can use the position data to identify a subspace corresponding to position 316a, position 316b, and/or predicted position 316n with field of view 310 of RADAR 306. As illustrated in FIG. 4A, the subspace can correspond to a portion of elements in a three-dimensional space.

At step 606, the process 600 includes collecting radar sensing data from the at least one subspace, wherein the radar sensing data corresponds to the at least one object. For instance, RADAR 306 can collect radar sensing data from the subspace corresponding to predicted position 316n. In some examples, collecting radar sensing data from the at least one subspace can include processing a portion of a radar data table that includes radar sensing data for the field of view of the radar sensor, wherein the portion of the radar data table corresponds to the at least one subspace. For instance, RADAR 306 can process element 458 and element 460 from grid 450, wherein element 458 and element 460 correspond to the subspace. In some aspects, collecting radar sensing data from the at least one subspace can include directing one or more transmissions in a direction corresponding to the at least one subspace. For example, RADAR 306 can implement beamforming to direct one or more RADAR transmissions in a direction corresponding to predicted position 316n.

In some aspects, the process 600 can include determining, based on the position data, a projected future position of the at least one object. For example, RADAR 306 can use position 316a and/or position 316b to determine predicted position 316n. In some cases, the position data can include a projected future position of the at least one object. For example, object data 324 can include predicted position 316n (e.g., determined by processor 302 and/or ML model 322). In some instances, the position data can include at least one of an elevation parameter (e.g., elevation 404), an azimuth parameter (e.g., azimuth 402), and a range parameter (e.g., range 406).

In some cases, the process 600 can include sending the radar sensing data to a perception stack of an autonomous vehicle. For example, RADAR 306 can send the radar sensing data associated with predicted position 316n to perception stack 112.

In some instances, the process 600 can include receiving one or more parameters that define an area of interest within the field of view of the radar sensor and collecting additional radar sensing data corresponding to the area of interest. For example, RADAR 306 can receive parameters that define zone of interest 320 and RADAR 306 can collect additional radar sensing data corresponding to zone of interest 320.

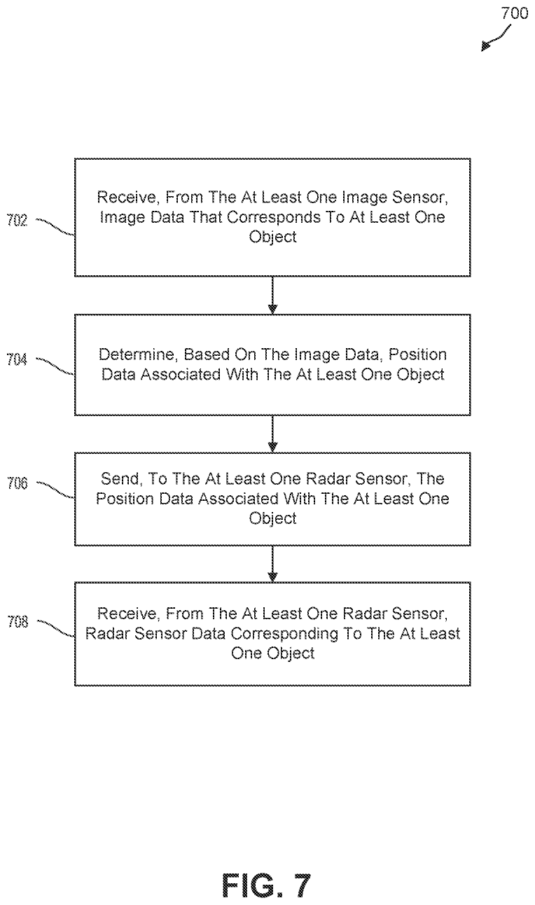

FIG. 7 illustrates a flowchart of an example process 700 for implementing RADAR sensing using prior data from an external sensor. Although the process 700 depicts a particular sequence of operations, the sequence may be altered without departing from the scope of the present disclosure. For example, some of the operations depicted may be performed in parallel or in a different sequence that does not materially affect the function of process 700. In other examples, different components of an example device or system that implements process 700 may perform functions at substantially the same time or in a specific sequence.

At step 702, the process 700 includes receiving, from the at least one image sensor, image data that corresponds to at least one object. For example, processor 302 can receive image data corresponding to person 314 from sensor 304.

At step 704, the process 700 includes determining, based on the image data, position data associated with the at least one object. For instance, processor 302 and/or ML model 322 can determine, based on the image data, position 316a and/or position 316b associated with person 314. In some aspects, the position data includes a projected future position of the at least one object. For example, the position data can include predicted position 316n corresponding to time t=x. In some cases, the position data can include at least one of an elevation parameter, an azimuth parameter, and a range parameter.

At step 706, the process 700 includes sending, to the at least one radar sensor, the position data associated with the at least one object. For example, processor 302 can send position data (e.g., object data 324) associated with person 314 to RADAR 306.

At step 708, the process 700 includes receiving, from the at least one radar sensor, radar sensor data corresponding to the at least one object. For example, processor 302 can receive radar sensor data corresponding to person 314 from RADAR 306. In some aspects, the radar sensor data corresponds to the at least one object at the projected future position. For example, the data received from RADAR 306 can correspond to person 314 at predicted position 316n.

In some examples, the process 700 can include providing the image data to a machine learning model configured to detect and identify objects in a vicinity of the AV. For example, processor 302 can provide the image data from sensor 304 to ML model 322, which can be configured to detect and identify objects in a vicinity of an AV. In some aspects, the machine learning model can be tuned to detect and identify objects that are associated with a low confidence metric. For instance, ML model 322 can identify partial detection 326 which can be associated with a relatively low confidence metric.

In some cases, the process 700 can include identifying, based on the image data, at least one occlusion; determining an area of interest proximate to the at least one occlusion; sending, to the at least one radar sensor, location data corresponding to the area of interest; and receiving, from the at least one radar sensor, additional radar sensor data corresponding to the area of interest. For example, processor 302 can identify occlusion 318 based on image data from sensor 304. In some aspects, processor 302 can determine zone of interest 320 proximate to occlusion 318. In some cases, processor 302 can send location data corresponding to zone of interest 320 to RADAR 306 and receive additional radar sensor data corresponding to zone of interest 320 from RADAR 306.

FIG. 8 illustrates an example processor-based system with which some aspects of the subject technology can be implemented. For example, processor-based system 800 can be any computing device making up local computing device 110, client computing device 170, a passenger device executing the ridesharing application 172, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 800 includes at least one processing unit (CPU or processor) 810 and connection 805 that couples various system components including system memory 815, such as read-only memory (ROM) 820 and random-access memory (RAM) 825 to processor 810.

Computing system 800 can include a cache of high-speed memory 812 connected directly with, in close proximity to, and/or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 can include an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 830 can include software services, servers, services, etc., that when the code that defines such software is executed by the processor 810, causes the system to perform a function. In some examples, a hardware service that performs a particular function can include the software component stored in a computer-readable medium in connection with the necessary hardware components, such as processor 810, connection 805, output device 835, etc., to carry out the function.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: receiving position data associated with at least one object, wherein the position data is based on sensor data obtained by at least one sensor; identifying, based on the position data, at least one subspace from a field of view of the radar sensor; and collecting radar sensing data from the at least one subspace, wherein the radar sensing data corresponds to the at least one object.

Aspect 2. The method of Aspect 1, further comprising: determining, based on the position data, a projected future position of the at least one object.

Aspect 3. The method of any of Aspects 1 to 2, wherein the position data includes a projected future position of the at least one object.

Aspect 4. The method of any of Aspects 1 to 3, wherein the position data includes at least one of an elevation parameter, an azimuth parameter, and a range parameter.

Aspect 5. The method of any of Aspects 1 to 4, wherein collecting radar sensing data from the at least one subspace further comprises: processing a portion of a radar data table that includes radar sensing data for the field of view of the radar sensor, wherein the portion of the radar data table corresponds to the at least one subspace.

Aspect 6. The method of any of Aspects 1 to 5, wherein collecting radar sensing data from the at least one subspace further comprises: directing one or more radar transmissions in a direction corresponding to the at least one subspace.

Aspect 7. The method of any of Aspects 1 to 6, wherein the at least one sensor includes at least one of an image sensor, a LIDAR sensor, and an ultrasonic sensor.

Aspect 8. The method of any of Aspects 1 to 7, further comprising: sending the radar sensing data to a perception stack of an autonomous vehicle.

Aspect 9. The method of any of Aspects 1 to 8, further comprising: receiving one or more parameters that define an area of interest within the field of view of the radar sensor; and collecting additional radar sensing data corresponding to the area of interest.

Aspect 10. An apparatus comprising: at least one memory; and at least one processor coupled to the at least one memory, wherein the at least one processor is configured to perform operations in accordance with any one of Aspects 1 to 9.

Aspect 11. An apparatus comprising means for performing operations in accordance with any one of Aspects 1 to 9.

Aspect 12. A non-transitory computer-readable medium comprising instructions that, when executed by an apparatus, cause the apparatus to perform operations in accordance with any one of Aspects 1 to 9.

Aspect 13. A method comprising: receiving, from at least one image sensor, image data that corresponds to at least one object; determining, based on the image data, position data associated with the at least one object; sending, to at least one radar sensor, the position data associated with the at least one object; and receiving, from the at least one radar sensor, radar sensor data corresponding to the at least one object.

Aspect 14. The method of Aspect 13, wherein the position data includes a projected future position of the at least one object.

Aspect 15. The method of Aspect 14, wherein the radar sensor data corresponds to the at least one object at the projected future position.

Aspect 16. The method of any of Aspects 13 to 15, wherein the position data includes at least one of an elevation parameter, an azimuth parameter, and a range parameter.

Aspect 17. The method of any of Aspects 13 to 16, further comprising: identifying, based on the image data, at least one occlusion; determining an area of interest proximate to the at least one occlusion; sending, to the at least one radar sensor, location data corresponding to the area of interest; and receiving, from the at least one radar sensor, additional radar sensor data corresponding to the area of interest.

Aspect 18. The method of any of Aspects 13 to 17, wherein determining the position data associated with the at least one object further comprises: providing the image data to a machine learning model configured to detect and identify objects in a vicinity of an autonomous vehicle.

Aspect 19. The method of Aspect 18, wherein the machine learning model is tuned to detect and identify objects that are associated with a low confidence metric.

Aspect 20. An apparatus comprising: at least one memory; and at least one processor coupled to the at least one memory, wherein the at least one processor is configured to perform operations in accordance with any one of Aspects 13 to 19.

Aspect 21. The apparatus of Aspect 20, wherein the apparatus corresponds to an autonomous vehicle.

Aspect 22. An apparatus comprising means for performing operations in accordance with any one of Aspects 13 to 19.

Aspect 23. A non-transitory computer-readable medium comprising instructions that, when executed by an apparatus, cause the apparatus to perform operations in accordance with any one of Aspects 13 to 19.

What is claimed is:

1. A radar sensor comprising:
at least one memory comprising instructions; and
at least one processor coupled to the at least one memory, wherein the at least one processor is configured to execute the instructions and cause the at least one processor to:
receive position data associated with at least one object, wherein the position data is based on sensor data obtained by at least one sensor;
identify, based on the position data, at least one subspace from a field of view of the radar sensor; and
collect radar sensing data from the at least one subspace, wherein the radar sensing data corresponds to the at least one object.

2. The radar sensor of claim 1, wherein the at least one processor is further configured to:
determine, based on the position data, a projected future position of the at least one object.

3. The radar sensor of claim 1, wherein the position data includes a projected future position of the at least one object.

4. The radar sensor of claim 1, wherein the position data includes at least one of an elevation parameter, an azimuth parameter, and a range parameter.

5. The radar sensor of claim 1, wherein to collect radar sensing data from the at least one subspace the at least one processor is further configured to:
process a portion of a radar data table that includes radar sensing data for the field of view of the radar sensor, wherein the portion of the radar data table corresponds to the at least one subspace.

6. The radar sensor of claim 1, wherein to collect radar sensing data from the at least one subspace the at least one processor is further configured to:
direct one or more radar transmissions in a direction corresponding to the at least one subspace.

7. The radar sensor of claim 1, wherein the at least one sensor includes at least one of an image sensor, a LIDAR sensor, and an ultrasonic sensor.

8. The radar sensor of claim 1, wherein the at least one processor is further configured to:
send the radar sensing data to a perception stack of an autonomous vehicle.

9. The radar sensor of claim 1, wherein the at least one processor is further configured to:
receive one or more parameters that define an area of interest within the field of view of the radar sensor; and
collect additional radar sensing data corresponding to the area of interest.

10. An autonomous vehicle (AV) comprising:
at least one image sensor;
at least one radar sensor;
at least one memory comprising instructions; and
at least one processor coupled to the at least one image sensor, the at least one radar sensor, and the at least one memory, wherein the at least one processor is configured to execute the instructions and cause the at least one processor to:
receive, from the at least one image sensor, image data that corresponds to at least one object;
determine, based on the image data, position data associated with the at least one object;
send, to the at least one radar sensor, the position data associated with the at least one object; and
receive, from the at least one radar sensor, radar sensor data corresponding to the at least one object.

11. The AV of claim 10, wherein the position data includes a projected future position of the at least one object.

12. The AV of claim 11, wherein the radar sensor data corresponds to the at least one object at the projected future position.

13. The AV of claim 10, wherein the position data includes at least one of an elevation parameter, an azimuth parameter, and a range parameter.

14. The AV of claim 10, wherein the at least one processor is further configured to:
identify, based on the image data, at least one occlusion;
determine an area of interest proximate to the at least one occlusion;
send, to the at least one radar sensor, location data corresponding to the area of interest; and
receive, from the at least one radar sensor, additional radar sensor data corresponding to the area of interest.

15. The AV of claim 10, wherein to determine the position data associated with the at least one object the at least one processor is further configured to:
provide the image data to a machine learning model configured to detect and identify objects in a vicinity of the AV.

16. The AV of claim 15, wherein the machine learning model is tuned to detect and identify objects that are associated with a low confidence metric.

17. A method comprising:
receiving position data associated with at least one object, wherein the position data is based on sensor data obtained by at least one sensor;
identifying, based on the position data, at least one subspace from a field of view of a radar sensor; and
collecting radar sensing data from the at least one subspace, wherein the radar sensing data corresponds to the at least one object.

18. The method of claim 17, further comprising:
determining, based on the position data, a projected future position of the at least one object.

19. The method of claim 17, wherein the position data includes at least one of an elevation parameter, an azimuth parameter, and a range parameter.

20. The method of claim 17, wherein collecting the radar sensing data from the at least one subspace further comprises:
processing a portion of a radar data table that includes radar sensing data for the field of view of the radar sensor, wherein the portion of the radar data table corresponds to the at least one subspace.
